(19) United States
(12) Patent Application Publication
(10) Pub. No.: US 2015/0346714 A1
(43) Pub. Date: Dec. 3, 2015

(54) NUMERICAL CONTROL DEVICE

(71) Applicants: Masafumi TAKAHASHI, Tokyo (JP); Mitsuo WATANABE, Tokyo (JP); Masakazu SAGASAKI, Tokyo (JP)

(72) Inventors: Masafumi TAKAHASHI, Tokyo (JP); Mitsuo WATANABE, Tokyo (JP); Masakazu SAGASAKI, Tokyo (JP)

(73) Assignee: MITSUBISHI ELECTRIC CORPORATION, Tokyo (JP)

(21) Appl. No.: 14/654,574

(22) PCT Filed: Jan. 30, 2013
(86) PCT No.: PCT/JP2013/052083

§ 371 Date: Jun. 22, 2015

(51) Int. Cl. G05B 19/4155

(52) U.S. Cl. CPC G05B 19/4155; G05B 2219/34396

(57) ABSTRACT

A numerical control device includes a program storage unit storing machining programs of systems; and a program analysis unit executing the machining programs independently for each system by analyzing the machining programs of the systems, wherein when control variable is not being executed in machining program of any system, if control variable is executed in machining program of any system, the program analysis unit permits only a system having executed the control variable to execute the control variable, and does not permit another system other than the system having executed the control variable to execute the control variable even when an attempt is made to execute the control variable in machining program of the other system, and when execution of the control variable is completed in the machining program being executed, the program analysis unit permits machining program of any system to execute the control variable.

### FIELD

The present invention relates to a numerical control device that executes control of each system in a plurality of systems.

### BACKGROUND

When machining with multiple systems is performed as combined machining, a different machining program of each system is created, and machining is performed by executing each machining program. With a numerical control device for multiple systems that perform such machining, there are a case where while one system is executing a machining program, the other systems stop the programs, and a case where a plurality of systems execute machining programs simultaneously. When a plurality of systems execute different programs simultaneously, machining time can be shortened.

With program internal commands (data) that are used when the machining programs of a plurality of systems are executed simultaneously, there are commands capable of saving a different value for each system even though the commands are the same for the systems and there are commands capable of saving one value that is common to the systems (one value for all of the systems) (for example, see Patent Literatures 1 and 2).

### CITATION LIST

### Patent Literatures

Patent Literature 1: Japanese Patent Application Laid-open No. H5-143130

Patent Literature 2: Japanese Patent Application Laid-open No. H3-196306

### SUMMARY

### Technical Problem

However, when different machining programs are simultaneously executed by a plurality of systems, the systems may simultaneously access a common command, or, after a certain system sets a value in the common command to, another system may immediately overwrite the value with respect to the common command. In such a case, a value intended to be used may be overwritten by another system before the value is used, and thus a desired operation cannot be performed.

The present invention has been achieved in view of the above problem, and an object of the present invention is to provide a numerical control device that can perform a desired operation of each system when simultaneously executing machining programs of a plurality of systems, even when the same command is used among the systems to save one common value among the systems.

### Solution to Problem

In order to solve the above problems and achieve the object, an aspect of the present invention is a numerical control device including: a program storage unit that stores therein machining programs of respective systems; and a program analysis unit that executes the machining programs independently for each of the systems by analyzing the machining programs of the systems, wherein in a case where a control variable is not being executed in a machining program of any of the systems, if a control variable is executed in a machining program of any of the systems, the program analysis unit permits only a system that has executed the control variable to execute the control variable, and does not permit another system other than the system that has executed the control variable to execute the control variable even when an attempt is made to execute the control variable in a machining program of the another system, and when execution of the control variable is completed in the machining program, the program analysis unit permits any one of the machining programs to execute the control variable.

### Advantageous Effects of Invention

According to the present invention, an effect is obtained where a desired operation of each system can be performed when simultaneously executing machining programs of a plurality of systems, even when the same command is used among the systems to save one common value among the systems.

### BRIEF DESCRIPTION OF DRAWINGS

FIG. 1 is a block diagram showing the configuration of an NC device according to a first embodiment.

FIG. 2 is an explanatory diagram of an exclusive control variable to be used in the NC device according to the first embodiment.

FIG. 3 is a flowchart showing a process procedure for setting a value in an exclusive control variable.

FIG. 4 is a flowchart showing a process procedure for setting “0” in an exclusive control variable.

FIG. 5 is a flowchart showing a process procedure for referring to an exclusive control variable.

FIG. 6 is a diagram showing an example of a machining program used by the NC device according to the first embodiment.

FIG. 7 is a flowchart showing an operation process procedure of each system when the machining program shown in FIG. 6 is executed.

FIG. 8 is a timing chart of system bits when the machining program shown in FIG. 6 is executed.

FIG. 9 is a block diagram showing the configuration of an NC device according to a second embodiment.

FIG. 10 is a flowchart showing a process procedure for setting a value in an exclusive control variable.

FIG. 11 is a diagram showing an example of a machining program used by the NC device according to the second embodiment.

FIG. 12 is a flowchart showing an operation process procedure of each system when the machining program shown in FIG. 11 is executed.

FIG. 13 is a timing chart of system bits when the machining program shown in FIG. 11 is executed.

FIG. 14 is a block diagram showing the configuration of an NC device according to a third embodiment.

FIG. 15 is an explanatory diagram of a process of specifying an exclusive-control specification parameter.

FIG. 16 is a diagram showing the configuration of an exclusive-control-variable specifying unit.

FIG. 17 is a diagram showing an example of a conventional machining program.

### DESCRIPTION OF EMBODIMENTS

A numerical control device according to embodiments of the present invention will be explained below in detail with reference to the accompanying drawings. The present invention is not limited to the embodiments.

### First Embodiment

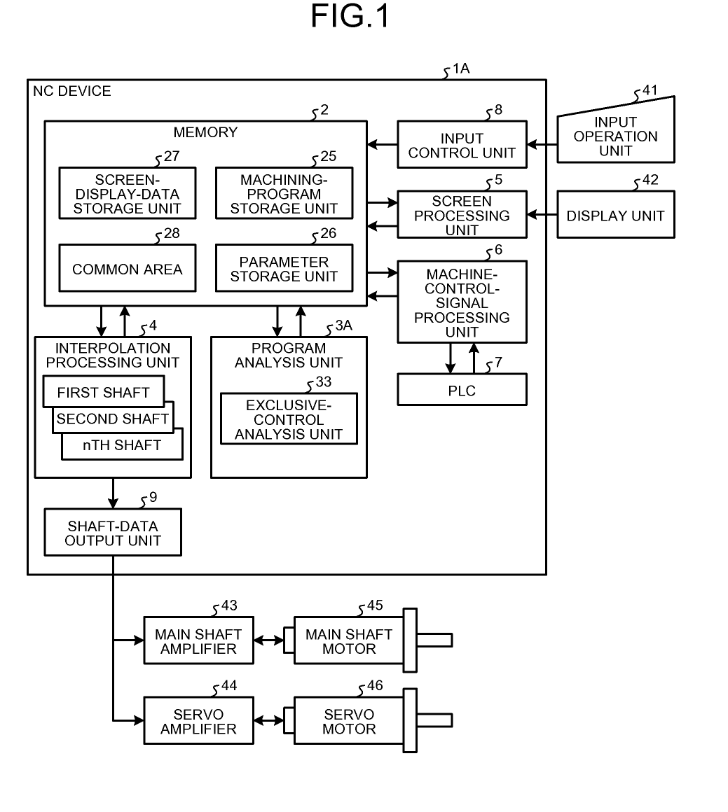

FIG. 1 is a block diagram showing the configuration of an NC device according to a first embodiment. An NC (Numerical Control) device 1A is a device that executes control of a multi-system machine including a plurality of systems. The NC device 1A performs an exclusive operation for each system when the systems simultaneously execute machining programs. The NC device 1A includes a memory 2, a program analysis unit 3A, an interpolation processing unit 4, a screen processing unit 5, a machine-control-signal processing unit 6, a PLC 7, an input control unit 8, and a shaft-data output unit 9.

The input control unit 8 is connected to an input operation unit 41. When the input operation unit 41 is operated by an operator, the input control unit 8 detects a change in a switch signal and the like, editing of a machining program, parameter changes, and the like. On the basis of the detected content, the input control unit 8 accesses each element in the memory 2 to perform a rewrite process, a read process, or the like of information stored in the memory 2. The input operation unit 41 is configured to include a mouse, a keyboard, and the like.

The memory 2 includes a machining-program storage unit 25, a parameter storage unit 26, a screen-display-data storage unit 27, and a common area 28. The machining-program storage unit 25 stores therein machining programs to be used for machining a workpiece. In the machining program, an operation content of a machine, a movement pathway of an edge tool, and the like required for machining a workpiece are described in a format decodable by the NC device 1A. The machining-program storage unit 25 of the present embodiment stores therein machining programs of respective systems as one machining program.

The parameter storage unit 26 stores therein parameters to be used for machining a workpiece. The parameters stored in the parameter storage unit 26 include data for determining the specification of the NC device 1A, condition data required for machine control, and the like.

The screen-display-data storage unit 27 stores therein data to be displayed on a screen. The screen-display-data storage unit 27 stores therein various types of data such as information on the current position of a tool or the like, information on the rotation position of a main shaft, the control mode of the NC device 1A, and the output state of various selection signals. The common area 28 stores therein temporary data required for analysis of machining programs, temporary data required for controlling a system that is controlling the machine operation, and the like.

The screen processing unit 5 is connected to a display unit 42. The screen processing unit 5 reads data in the screen-display-data storage unit 27 and causes the display unit 42 to display the data. The display unit 42 is a display device, such as a liquid crystal monitor, that displays data indicated by the screen processing unit 5.

The program analysis unit 3A sequentially reads, from the top, a machining program that is specified by the input operation unit 41 from among the machining programs stored in the machining-program storage unit 25. The program analysis unit 3A analyzes and executes the machining program according to the process procedures specified for each of the various NC commands. The program analysis unit 3A analyzes the machining program, while temporarily storing, in the common area 28, data or the like being analyzed, and transfers the analysis result to the interpolation processing unit 4. The program analysis unit 3A according to the present embodiment analyzes the machining program of each of the systems and performs a process for each of the systems.

The program analysis unit 3A according to the present embodiment includes an exclusive-control analysis unit 33. The exclusive-control analysis unit 33 analyzes an exclusive control variable. The exclusive control variable is a command (data) in a machining program that is used when simultaneously executing machining programs of a plurality of systems.

In a state where access permission to common data is granted to any one system, the exclusive-control analysis unit 33 prohibits the other systems from accessing the common data. In a state where the other systems are prohibited from accessing the common data, the exclusive-control analysis unit 33 causes the other systems that call for access to the common data to repeatedly check access permission until the other systems are permitted to access the common data. After the system permitted to access the common data has completed accessing the common data, the exclusive-control analysis unit 33 permits any one of the other systems that is calling for access to the common data to access the common data.

The interpolation processing unit 4 performs, for each shaft (a first shaft to an nth shaft (where n is a natural number)), for example, linear or circular interpolation on a relative displacement amount obtained from the machining program. The interpolation processing unit 4 sends the interpolated relative displacement amount to the shaft-data output unit 9 as output data.

The shaft-data output unit 9 inputs the interpolated relative displacement amount to a main shaft amplifier 43 and a servo amplifier 44 of each shaft. The main shaft amplifier 43 outputs drive power corresponding to the interpolated relative displacement amount to a main shaft motor 45 to cause the main shaft motor 45 to perform machining. The servo amplifier 44 outputs drive power corresponding to the interpolated relative displacement amount to a servo motor 46 to cause the servo motor 46 to perform machining.

The machine-control-signal processing unit 6 reads information that is related to control of a machine peripheral device and is output from the program analysis unit 3A to the memory 2. The machine-control-signal processing unit 6 outputs the read information to the PLC (Programmable Logic Controller) 7 to provide control information to a ladder circuit. The machine-control-signal processing unit 6 outputs various control signals such as on/off sent from an external input/output signal I/F (not shown) to the machine. The machine-control-signal processing unit 6 writes external signals input from the machine via the PLC 7 into the common area 28 of the memory 2. Accordingly, the machine-control-signal processing unit 6 causes signals for control and external signals to control the NC device 1A. As a result, control of the machine proceeds correctly.

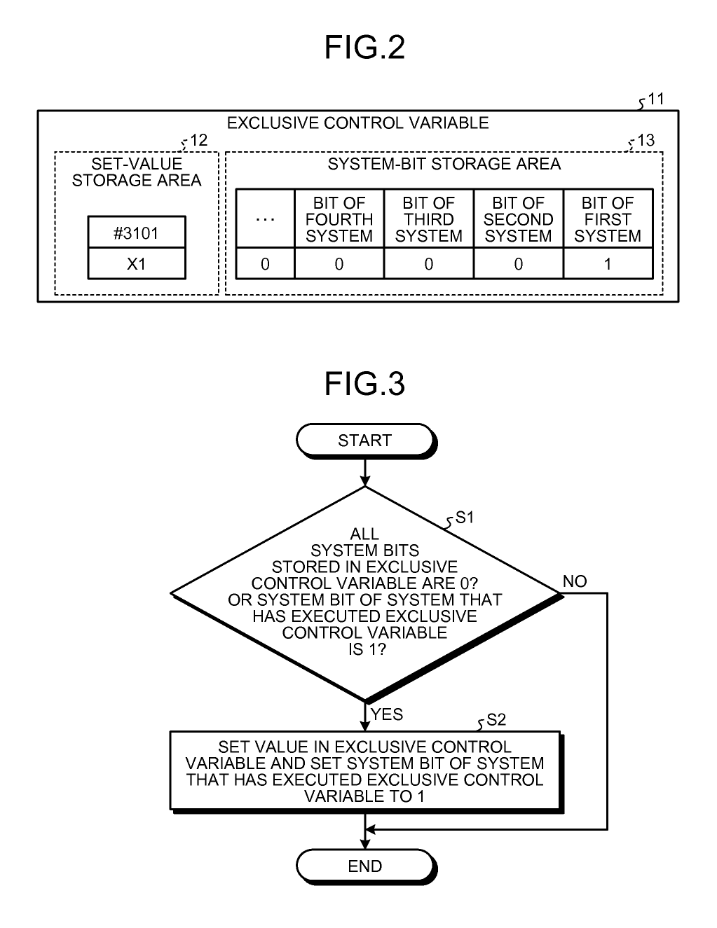

The exclusive control variable used in the NC device 1A of the present embodiment is explained next. FIG. 2 is an explanatory diagram of an exclusive control variable used by the NC device 1A according to the first embodiment. An exclusive control variable 11 is configured to include a set-value storage area 12 that stores therein a set value and a system-bit storage area 13.

The set-value storage area 12 is an area that stores therein a value set in a common command for each system. The common command for each system is a command that can save one value common to each system (one value among the systems). FIG. 2 shows a case where a value “1” is set in an exclusive control variable #3101, which is a common command, in the exclusive control variable 11.

The system-bit storage area 13 is an area that stores therein a bit (system bit) of each system. A system bit indicates whether a system can set a value in the exclusive control variable 11. When it is “0”, the system bit indicates that the system cannot set a value in the exclusive control variable 11, and when it is “1”, the system bit indicates that the system can set a value in the exclusive control variable 11. FIG. 2 shows a state where the system bit of a first system is set to “1” and system bits of the other systems are set to “0”. In the exclusive control variable 11, system bits of respective systems are set for each type of the exclusive control variable 11.

FIG. 3 is a flowchart showing a process procedure for setting a value in an exclusive control variable. When an attempt is made to set a value (a value indicating process start) in the exclusive control variable 11 by any one system, the exclusive-control analysis unit 33 checks whether all the system bits stored in the exclusive control variable 11 are “0”, or the system bit that has executed (started) the exclusive control variable 11 is “1” (Step S1).

When all the system bits stored in the exclusive control variable 11 are “0”, or the system bit that has executed (started) the exclusive control variable 11 is “1” (YES at Step S1), the exclusive-control analysis unit 33 sets a value in the set-value storage area 12 of the exclusive control variable 11 and sets the system bit that has executed a command to “1” (Step S2).

For example, when a value is set in the exclusive control variable by the first system, if all the system bits are “0” or the system bit of the first system is “1”, the exclusive-control analysis unit 33 sets a value in the set-value storage area 12. When the system bit of the first system is “0”, the exclusive-control analysis unit 33 sets the system bit of the first system to “1”. When the first system is executed, even when the system bit of the first system has already been set to “1”, the operation to set the system bit to “1” is performed.

In contrast, when an attempt is made to set a value in the exclusive control variable 11, if a system bit other than the system that has executed the exclusive control variable 11 is “1” (NO at Step S1), the exclusive-control analysis unit 33 does not set a value in the set-value storage area 12 and maintains the system bit as “0”. For example, when execution of the second system has started, if the system bit of the first system is “1”, the exclusive-control analysis unit 33 does not set a value in the set-value storage area 12 and maintains the system bit of the second system as “0”.

In this manner, when a value is set in the exclusive control variable 11 of any one system, the exclusive-control analysis unit 33 does not permit the other systems to set a value in the exclusive control variable 11. Therefore, in the NC device 1A, in order to enable a value to be set in the exclusive control variable 11 from the other systems, it is necessary to set “0” in the exclusive control variable 11 by the system that has set a value.

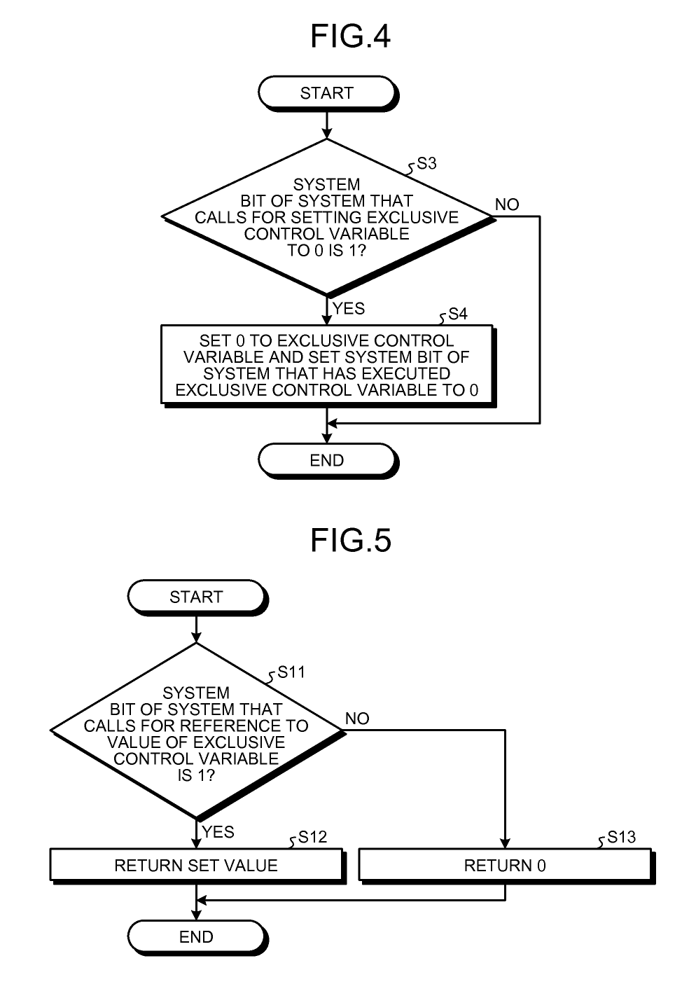

FIG. 4 is a flowchart showing a process procedure for setting “0” in an exclusive control variable. After any one system has executed the exclusive control variable 11 and sets a value, when the value of the exclusive control variable 11 needs to be set to “0”, the exclusive-control analysis unit 33 checks whether the system bit of the system that calls for setting the value of the exclusive control variable 11 to “0” is “1” (Step S3).

When the system bit of the system that calls for setting the value of the exclusive control variable 11 to “0” is “1” (YES at Step S3), the exclusive-control analysis unit 33 sets “0” in the exclusive control variable 11 and sets the system bit of the system that has executed the exclusive control variable 11 to “0” (Step S4).

In contrast, when the system bit of the system that calls for setting the value of the exclusive control variable 11 to “0” is not “1” (NO at Step S3), the exclusive-control analysis unit 33 does not change the exclusive control variable 11 and the system bit that has executed the exclusive control variable 11. Therefore, the exclusive control variable 11 remains set to “1”, and the system bit that has executed the exclusive control variable 11 remains as “1”.

In this manner, after the exclusive control variable 11 is executed by any one system and a value is set, if the value of the exclusive control variable 11 is to be set to “0”, only the system in which the system bit stored in the exclusive control variable 11 is “1” is permitted to change the value set in the exclusive control variable 11 to “0”. In other words, only the system that has executed the exclusive control variable 11 can change the value set in the exclusive control variable 11 to “0”, and can set the system bit that has executed a command to “0”, as a process of Step S4.

FIG. 5 is a flowchart showing a process procedure for referring to an exclusive control variable. After the exclusive control variable 11 is executed and a value is set in any one system, when the value of the exclusive control variable 11 (a set value) is referred to, the exclusive-control analysis unit 33 checks whether the system bit of a system that calls for a reference to the value of the exclusive control variable 11 is “1” (Step S11).

When the system bit of the system that calls for a reference to the value of the exclusive control variable 11 is “1” (YES at Step S11), the exclusive-control analysis unit 33 returns the value set in the exclusive control variable 11 as a reference value (Step S12). In contrast, when the system bit of the system that calls for a reference to the value of the exclusive control variable 11 is not “1” (NO at Step S11), the exclusive-control analysis unit 33 returns “0” as the reference value (Step S13).

In this manner, after any one system has executed the exclusive control variable 11 and a value is set, when the value of the exclusive control variable is to be referred to, the exclusive-control analysis unit 33 returns the value (valid) set in the exclusive control variable 11 only to the system having the system bit of “1”, and returns “0” (invalid) to the system having the system bit of “0”.

In other words, when the exclusive control variable 11 is executed in the machining program of any one system (the first system), even when the exclusive control variable 11 is referred to in the machining program of a system (the second system) other than the first system, the exclusive-control analysis unit 33 designates the exclusive control variable as invalid. When the exclusive control variable 11 is referred to in the machining program of the first system, the exclusive-control analysis unit 33 designates the exclusive control variable 11 as valid and returns the set value.

When the exclusive control variable is not being executed in the machining program of any one system, if the exclusive control variable is executed in the machining program of the first system, the exclusive-control analysis unit 33 permits only the first system to execute the exclusive control variable. Even when an attempt is made to execute the exclusive control variable in the machining program of a system other than the first system, the exclusive-control analysis unit 33 does not permit this system to execute the exclusive control variable.

As described above, the NC device 1A sets the bit for each system in the exclusive control variable 11, and permits only one system to set the value in the exclusive control variable 11 on the basis of the bit of each system. Therefore, an exclusive command for each system can be issued.

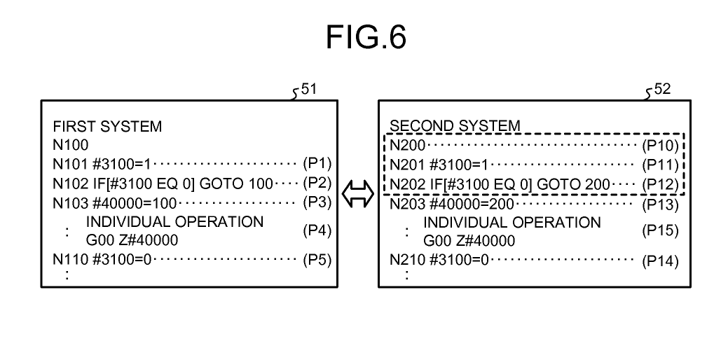

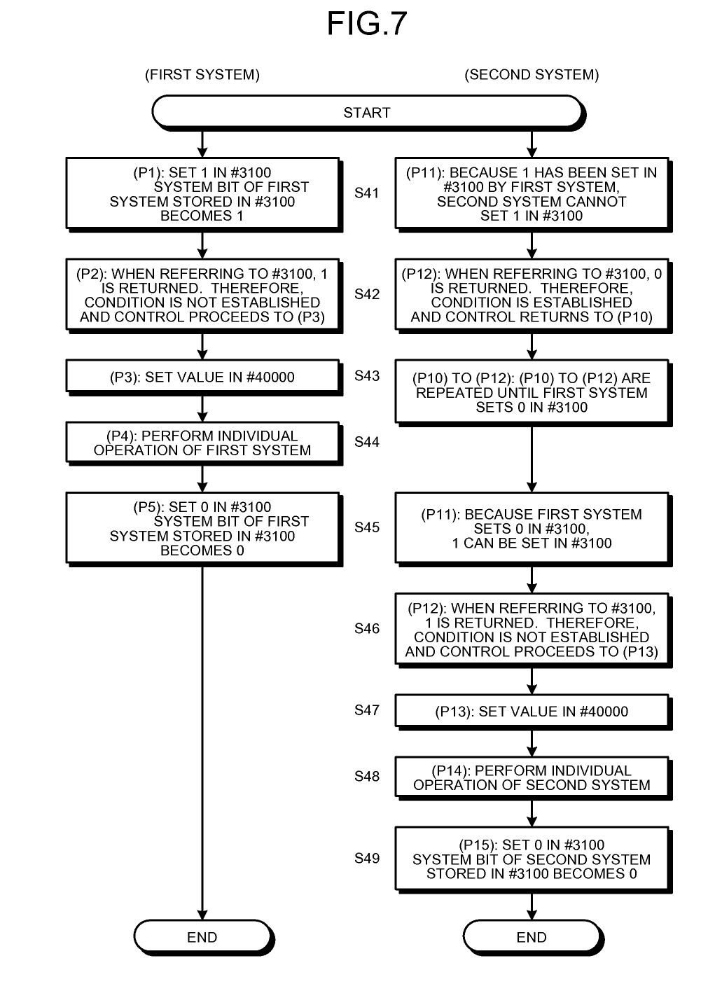

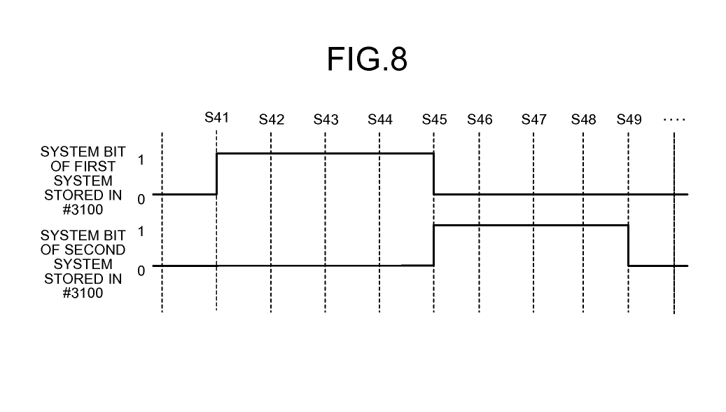

FIG. 6 is a diagram showing an example of a machining program used by the NC device according to the first embodiment. FIG. 7 is a flowchart showing an operation process procedure of each system when the machining program shown in FIG. 6 is executed. FIG. 8 is a timing chart of system bits when the machining program shown in FIG. 6 is executed.

A machining program 51 is a machining program for controlling the first system, and a machining program 52 is a machining program for controlling the second system. The machining programs 51 and 52 use an exclusive control variable #3100. The machining programs 51 and 52 control the systems, respectively, such that simultaneous access to an exclusive control variable #40000 and overwriting thereof before it is used are not allowed. In other words, the exclusive control variable #3100 is used as the exclusive control variable 11. In the present embodiment, the exclusive-control analysis unit 33 performs the processes of the machining programs 51 and 52.

When the machining programs 51 and 52 are executed simultaneously, a process P1 performed by the first system and a process P2 performed by the second system are performed simultaneously. In the operation at this point, as shown in FIG. 7, “1” is set in the exclusive control variable #3100 by the first system. Before this operation is performed, the states of the system bits stored in the exclusive control variable #3100 are all “0”, and thus the exclusive-control analysis unit 33 sets the system bit of the first system stored in the exclusive control variable #3100 to “1”.

Meanwhile, even when an attempt is made to set “1” in the exclusive control variable #3100 by the second system, the exclusive-control analysis unit 33 does not permit such a setting to be made. This is because in the process P1, the first system has set “1” in the exclusive control variable #3100 and the system bit of the first system becomes “1” (valid). Therefore, the second system cannot set a value in #3100, and the exclusive control variable #3100 of the second system is “0” (Step S41).

Accordingly, at Step S41, the system bit of the first system stored in the exclusive control variable #3100 changes from “0” to “1”, and the system bit of the second system stored in the exclusive control variable #3100 remains as “0”.

Thereafter, in the machining program 51 of the first system, a process P2 is performed, and in the machining program 52 of the second system, a process P12 is performed. Specifically, in the machining program 51 of the first system, the exclusive control variable #3100 is referred to, and a value “1” is returned. Meanwhile, in the machining program 52 of the second system, the exclusive control variable #3100 is referred to, and a value “0” is returned. In other words, when the exclusive control variable #3100 is referred to in the machining program of a system other than the first system, the value “0” is returned.

Therefore, in the first system, because #3100=0 is not established, control proceeds to a process P3, which is the next process. Meanwhile, in the second system, because #3100=0 is established, control returns to a process P10 (Step S42).

In the machining program 51 of the first system, as a process P3, data (a value such as 100) is set in the exclusive control variable #40000. Meanwhile, in the machining program 52 of the second system, because the system bit of the first system stored in the exclusive control variable #3100 is “1”, the second system cannot set a value and therefore repeats processes P10 to P12 (Step S43).

Furthermore, in the machining program 51 of the first system, an individual operation is performed by the first system by using the set value of #40000 intended to be used by the first system (a process P4). Meanwhile, in the machining program 52 of the second system, the processes P10 to P12 are repeated (Step S44).

That is, as shown in FIG. 8, during Steps S41 to S44, the system bit of the first system stored in the exclusive control variable #3100 is “1”, and the system bit of the second system stored in the exclusive control variable #3100 is “0”.

Thereafter, in the machining program 51 of the first system, as a process P5, “0” is set in the exclusive control variable #3100 in which “1” has been set, thereby completing the individual operation of the first system (Step S45). At Step S45, the system bit of the first system stored in the exclusive control variable #3100 changes from “1” to “0”.

Accordingly, in the machining program 52 of the second system, “1” can be set in the exclusive control variable #3100 (Step S45). In the machining program 52 of the second system, as a process P11, “1” is set in the exclusive control variable #3100. At Step S45, the system bit of the second system stored in the exclusive control variable #3100 changes from “0” to “1”.

Thereafter, in the machining program 52 of the second system, the process P12 is performed. Specifically, in the machining program 52 of the second system, the exclusive control variable #3100 is referred to and a value “1” is returned. Therefore, in the second system, because #3100=0 is not established, control proceeds to a process P13, which is the next process (Step S46).

In the machining program 52 of the second system, as the process P13, data (a value such as 200) is set in the exclusive control variable #40000 (Step S47). In the machining program 52 of the second system, an individual operation is performed by the second system by using the set value of #40000 intended to be used by the second system (a process P14) (Step S48).

That is, as shown in FIG. 8, during Steps S45 to S48, the system bit of the first system stored in the exclusive control variable #3100 is “0”, and the system bit of the second system stored in the exclusive control variable #3100 is “1”.

Thereafter, in the machining program 52 of the second system, as a process P15, “0” is set in the exclusive control variable #3100 in which “1” has been set, thereby completing the individual operation of the second system (Step S49). At Step S49, the system bit of the second system stored in the exclusive control variable #3100 changes from “1” to “0”, and thus all the system bits become “0”. Thereafter, any of the systems can issue a command with respect to the exclusive control variable #3100.

In this manner, in the NC device 1A, by using the exclusive control variable #3100, only the system that has executed the exclusive control variable first can refer, change, and clear a value. Therefore, for example, such a case that the second system executes the exclusive control variable while the first system is executing the exclusive control variable depending on the operation timings among the systems does not occur. Accordingly, it can be prevented that while the exclusive control variable #40000, which is common data, is being used, a plurality of systems simultaneously access #40000 and #40000 is overwritten at an unexpected timing. Consequently, it is easy to prevent each system from not operating desirably, thereby enabling each system to perform an individually intended operation by the machining program.

As described above, according to the first embodiment, a system bit indicating access permission to common data is set for each of the systems, and when access permission is granted to any one system, the other systems are not granted access permission. Therefore, simultaneous access to the common data and overwriting thereof before the common data is used can be prevented. Accordingly, when machining programs of a plurality of systems are executed simultaneously, even when a common value is to be saved among the systems by using the same command among the systems, the desired operation can be performed by each of the systems.

### Second Embodiment

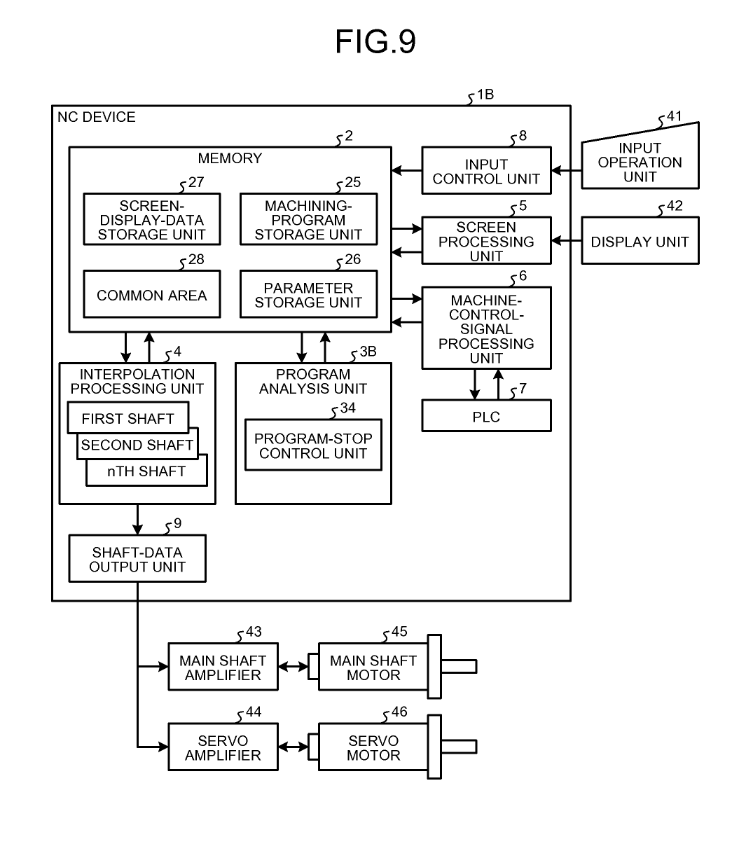

A second embodiment of the present invention is explained with reference to FIGS. 9 to 13. In the second embodiment, the machining program is stopped until a system that calls for access to the common data is permitted to access the common data.

FIG. 9 is a block diagram showing the configuration of an NC device according to the second embodiment. Among the constituent elements shown in FIG. 9, constituent elements achieving the same functions as those of the NC device 1A according to the first embodiment shown in FIG. 1 are denoted by like reference signs, and redundant explanations thereof are omitted.

When compared to the NC device 1A, an NC device 1B includes a program analysis unit 3B instead of the program analysis unit 3A. The program analysis unit 3B includes a program-stop control unit 34 instead of the exclusive-control analysis unit 33.

In a state where access permission to common data is granted to any one system, the program-stop control unit 34 prohibits the other systems from accessing the common data. Specifically, in a state where the other systems are prohibited from accessing the common data, the program-stop control unit 34 stops the programs of the other systems that call for access to the common data until the other systems are permitted such access. After the system permitted to access the common data has completed accessing the common data, the program-stop control unit 34 releases (resumes) the stop of the machining program of any one of the other systems that call for access to the common data.

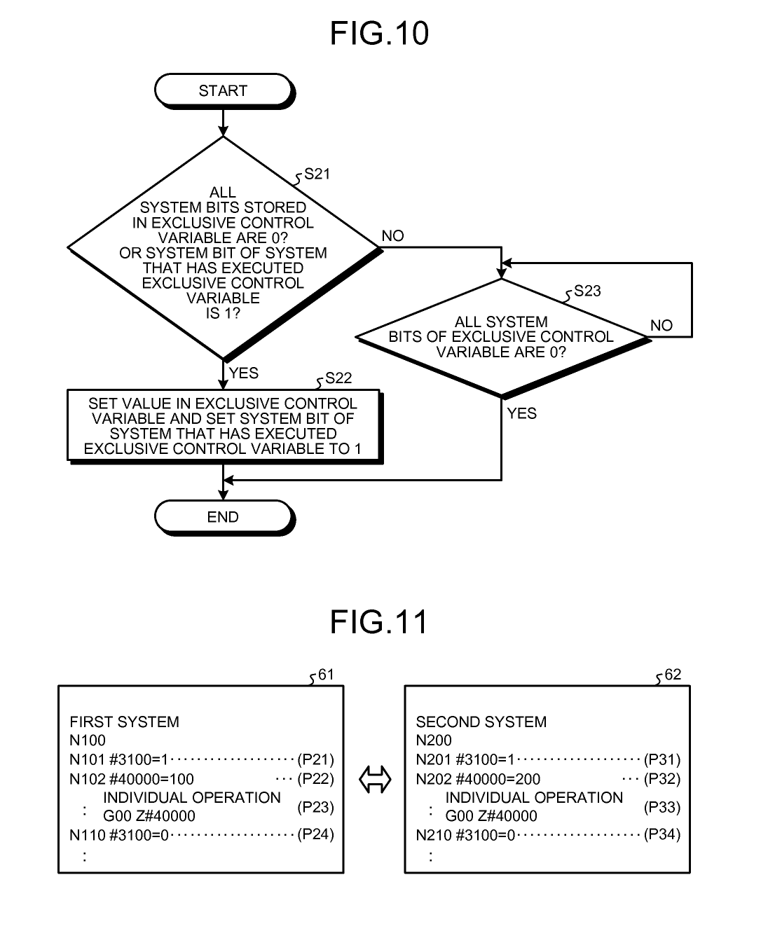

FIG. 10 is a flowchart showing a process procedure for setting a value in an exclusive control variable. Among the processes shown in FIG. 10, explanations of the same processes as those of the data setting process of the first embodiment shown in FIG. 3 are omitted.

When an attempt is made to set a value in the exclusive control variable 11 by any one system, the program-stop control unit 34 checks whether all the system bits stored in the exclusive control variable 11 are “0”, or the system bit that has executed the exclusive control variable 11 is “1” (Step S21).

When all the system bits stored in the exclusive control variable 11 are “0”, or the system bit that has executed the exclusive control variable 11 is “1” (YES at

Step S21), the program-stop control unit 34 sets a value in the exclusive control variable 11 and sets the system bit that has executed a command to “1” (Step S22).

In contrast, when an attempt is made to set a value in the exclusive control variable 11, if a system bit other than the system that has started executing the exclusive control variable 11 is “1” (NO at Step S21), the program-stop control unit 34 checks whether all the system bits stored in the exclusive control variable 11 are “0” (Step S23).

When not all the system bits stored in the exclusive control variable 11 are “0” (NO at Step S23), the program-stop control unit 34 does not execute the next command of the system that is trying to set a value in the exclusive control variable 11, and stops the machining program. In other words, when the exclusive control variable is executed, if the system bit of another system has already been set to “1”, the system that is trying to set a value in the exclusive control variable 11 is caused to stop the machining program.

When all the system bits stored in the exclusive control variable 11 are “0” (YES at Step S23), the program-stop control unit 34 causes the system that has stopped the machining program to perform the next process. In other words, the program-stop control unit 34 resumes the machining program that has been stopped.

In this manner, when a value is set in the exclusive control variable 11 of any one system, the other systems cannot set a value in the exclusive control variable 11. In order to enable a value to be set in the exclusive control variable 11 from the other systems, it is necessary to set “0” in the exclusive control variable 11 by the system that has set a value. The flow of clearing the exclusive control variable is shown in FIG. 4 as in the first embodiment.

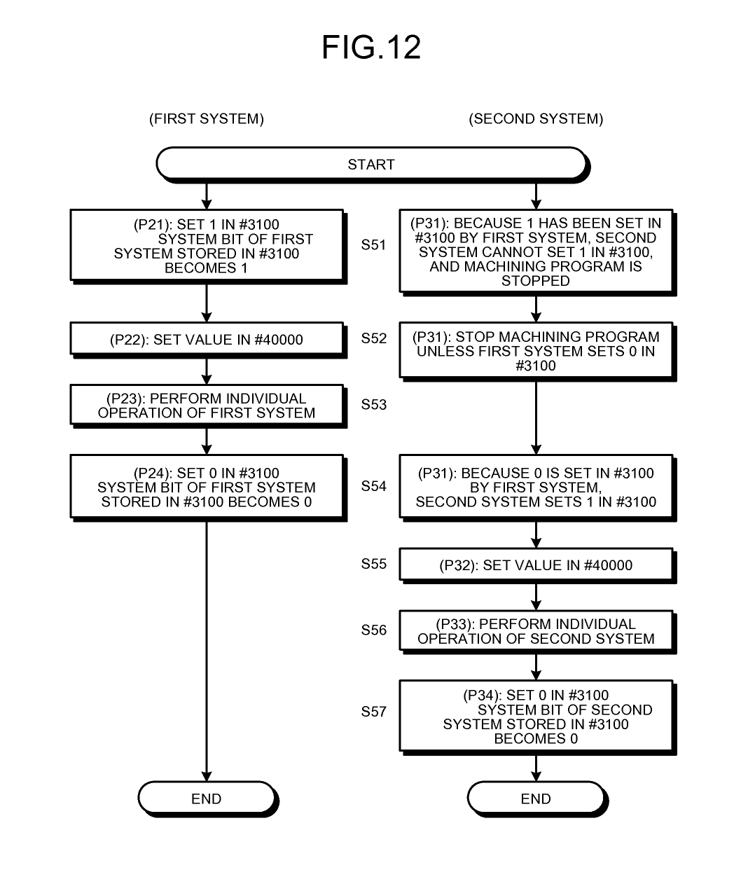

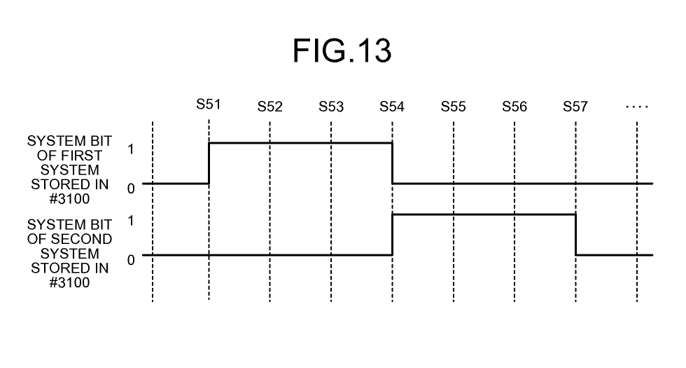

FIG. 11 is a diagram showing an example of a machining program used by the NC device according to the second embodiment. FIG. 12 is a flowchart showing an operation process procedure of each system when the machining program shown in FIG. 11 is executed. FIG. 13 is a timing chart of system bits when the machining program shown in FIG. 11 is executed.

A machining program 61 is a machining program for controlling the first system, and a machining program 62 is a machining program for controlling the second system. The machining programs 61 and 62 use the exclusive control variable #3100. The machining programs 61 and 62 control the systems, respectively, such that simultaneous access to the exclusive control variable #40000 and overwriting thereof before it is used are not allowed. In the present embodiment, the program-stop control unit 34 performs the processes of the machining programs 61 and 62.

When the machining programs 61 and 62 are executed simultaneously, a process P21 performed by the first system and a process P31 performed by the second system are performed simultaneously. In the operation at this point, as shown in FIG. 13, “1” is set in the exclusive control variable #3100 by the first system. Before this operation is performed, the states of the system bits stored in the exclusive control variable #3100 are all “0”, and thus the program-stop control unit 34 sets the system bit of the first system stored in the exclusive control variable #3100 to “1”.

Meanwhile, even when an attempt is made to set “1” in the exclusive control variable #3100 by the second system, the program-stop control unit 34 does not permit such a setting to be made. This is because in the process P1, the first system has set “1” in the exclusive control variable #3100 and the system bit of the first system becomes “1”. Therefore, the second system cannot set a value in #3100. At this point, the program-stop control unit 34 stops the machining program 62 of the second system (Step S51).

Accordingly, at Step S51, the system bit of the first system stored in the exclusive control variable #3100 changes from “0” to “1”, and the system bit of the second system stored in the exclusive control variable #3100 remains as “0”.

In the machining program 61 of the first system, as a process P22, data (a value such as 100) is set in the exclusive control variable #40000. Meanwhile, in the machining program 62 of the second system, because the system bit of the first system stored in the exclusive control variable #3100 is “1”, the second system cannot set a value and therefore the machining program 62 remains in the stopped state. In the second system, unless the system bit of the exclusive control variable #3100 becomes “0” in the first system, the stopped state of the machining program 62 is maintained (Step S52).

Furthermore, in the machining program 61 of the first system, an individual operation is performed by the first system by using the set value of #40000 intended to be used by the first system (a process P23). Meanwhile, in the machining program 62 of the second system, the machining program 62 remains in the stopped state (Step S53).

That is, as shown in FIG. 13, during Steps S51 to S53, the system bit of the first system stored in the exclusive control variable #3100 is “1”, and the system bit of the second system stored in the exclusive control variable #3100 is “0”.

Thereafter, in the machining program 61 of the first system, as a process P24, “0” is set in the exclusive control variable #3100 in which “1” has been set, thereby completing the individual operation of the first system (Step S54). At Step S54, the system bit of the first system stored in the exclusive control variable #3100 changes from “1” to “0”.

Accordingly, in the machining program 62 of the second system, “1” can be set in the exclusive control variable #3100. In the machining program 62 of the second system, as a process P31, “1” is set in the exclusive control variable #3100 (Step S54). At Step S54, the system bit of the second system stored in the exclusive control variable #3100 changes from “0” to “1”.

Then, in the machining program 62 of the second system, as a process P32, data (a value such as 200) is set in the exclusive control variable #40000 (Step S55). Further, in the machining program 62 of the second system, an individual operation is performed by the second system by using the set value of #40000 intended to be used by the second system (a process P33) (Step S56).

That is, as shown in FIG. 13, during Steps S54 to S57, the system bit of the first system stored in the exclusive control variable #3100 is “0”, and the system bit of the second system stored in the exclusive control variable #3100 is “1”.

Thereafter, in the machining program 62 of the second system, as a process P34, “0” is set in the exclusive control variable #3100 in which “1” has been set, thereby completing the individual operation of the second system (Step S57). At Step S57, the system bit of the second system stored in the exclusive control variable #3100 changes from “1” to “0”, and thus all the system bits become “0”. Thereafter, any of the systems can issue a command with respect to the exclusive control variable #3100.

In this manner, in the NC device 1B, when the system bit of a certain system with respect to the exclusive control variable has been set to “1”, if another system attempts to set data in the exclusive control variable, the machining program is stopped until data setting is permitted. Because the machining program is stopped, a machining program that repeats a do-nothing operation until data setting is permitted with respect to the exclusive control variable need not be created as in the machining programs 61 and 62. Therefore, programming of the machining program that performs an exclusive operation for each system is facilitated.

In this manner, according to the second embodiment, a system bit indicating access permission to common data is set for each of the systems, and when access permission is granted to any one system, machining programs of the other systems that call for access to the common data are stopped. Accordingly, simultaneous access to the common data and overwriting thereof before the common data is used can be prevented. Therefore, the desired operation can be performed by each of the systems by using a simple machining program.

### Third Embodiment

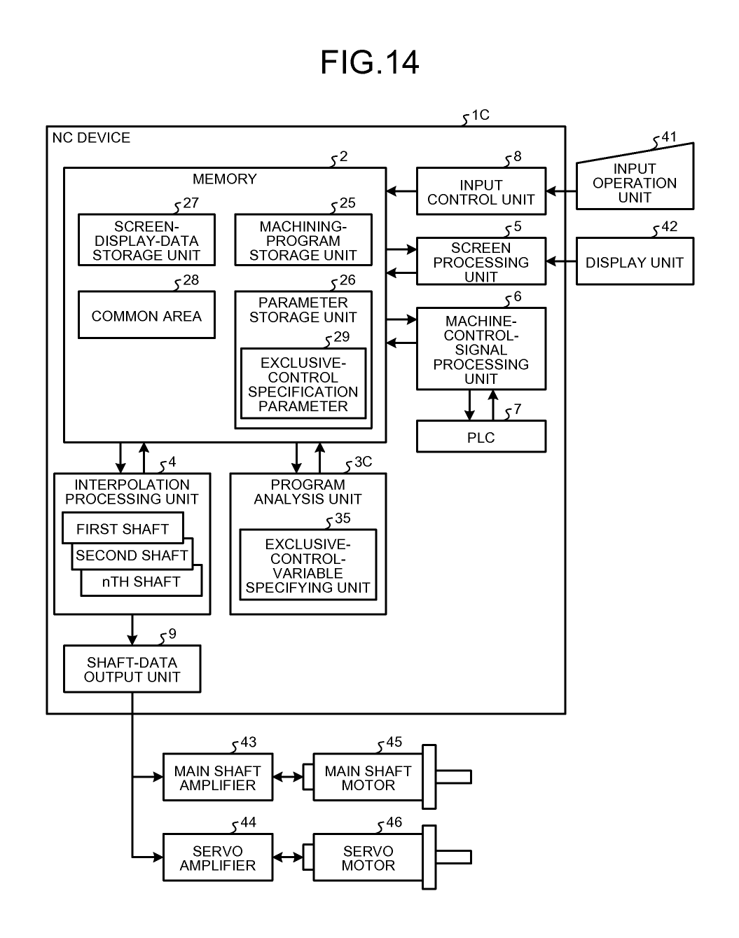

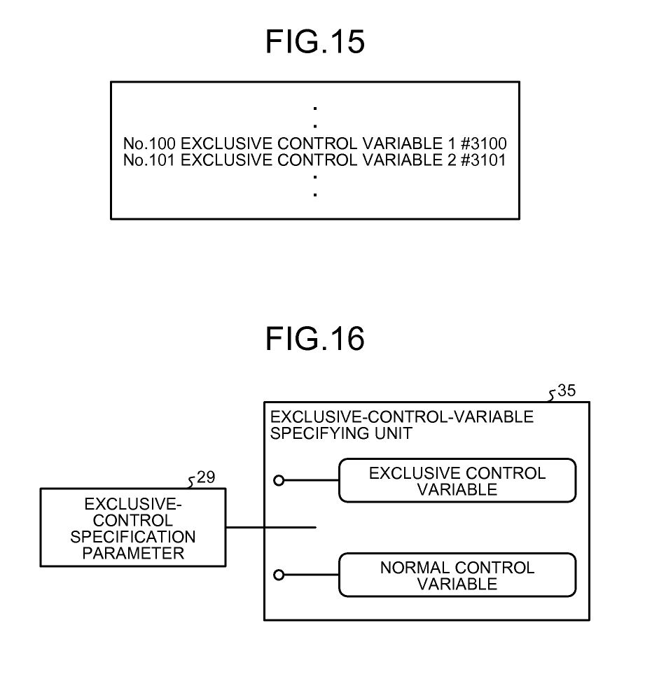

A third embodiment of the present invention is explained next with reference to FIGS. 14 and 15. In the third embodiment, a variable intended to be set as the exclusive control variable is set, for example, as #3100 and #3101, and the set variable is used as the exclusive control variable and a variable that has not been set is used as a normal control variable.

FIG. 14 is a block diagram showing the configuration of an NC device according to the third embodiment. Among the constituent elements shown in FIG. 14, constituent elements achieving the same functions as those of the NC device 1A according to the first embodiment shown in FIG. 1 are denoted by like reference signs, and redundant explanations thereof are omitted.

When compared to the NC device 1A, an NC device 1C includes a program analysis unit 3C instead of the program analysis unit 3A. The program analysis unit 3C includes an exclusive-control-variable specifying unit 35 instead of the exclusive-control analysis unit 33.

Further, according to the present embodiment, a variable of a control command to be specified as the exclusive control variable (an exclusive-control specification parameter 29) is set in the parameter storage unit 26. The control variable to be specified as the exclusive control variable is, for example, the exclusive control variable explained in the first and second embodiments. A control variable that is not specified as the exclusive control variable in the parameter storage unit 26 is used as a normal control variable.

The exclusive-control-variable specifying unit 35 switches a control variable to be executed between the exclusive control variable and the normal control variable, on the basis of the exclusive-control specification parameter 29 set in the parameter storage unit 26.

The exclusive-control-variable specifying unit 35 executes, with respect to the exclusive control variable specified by the exclusive-control specification parameter 29, the machining program by performing a similar process to that of the exclusive-control analysis unit 33 or the program-stop control unit 34.

FIG. 15 is an explanatory diagram of a process of specifying the exclusive-control specification parameter. The NC device 1C displays parameter items such as “exclusive control variable 1” and “exclusive control variable 2” on the display unit 42. The operator sets #3100, #3101, and the like as a variable intended to be specified as the exclusive control variable (the exclusive-control specification parameter 29) in the parameter items. The operator sets a variable intended to be specified as the exclusive control variable by using the input operation unit 41. At this point, the exclusive-control specification parameter 29 specified by an external input from the operator is stored in the parameter storage unit 26. Accordingly, the variable set as the exclusive-control specification parameter 29 in the parameter storage unit 26 is used as the exclusive control variable.

FIG. 16 is a diagram showing the configuration of the exclusive-control-variable specifying unit 35. When a control variable is input to the exclusive-control-variable specifying unit 35, the exclusive-control-variable specifying unit 35 performs switching between exclusive control and normal control on the basis of the exclusive-control specification parameter 29.

Specifically, when the input control variable is a control variable specified as the exclusive-control specification parameter 29, the exclusive-control-variable specifying unit 35 switches over to exclusive control using the exclusive control variable. Conversely, when the input control variable is a control variable not specified as the exclusive-control specification parameter 29, the exclusive-control-variable specifying unit 35 switches over to normal control using the normal control variable.

In this manner, by enabling switching of control, the machining program can be used by switching the exclusive-control specification parameter 29 with respect to a program currently created as an exclusive control variable, without rewriting the machining program with respect to a new exclusive control variable. Therefore, the exclusive control variable explained in the first and second embodiments can also be executed easily with respect to a machining program currently created as a normal control variable.

In this manner, according to the third embodiment, because a variable intended to be set as an exclusive control variable is set as the exclusive-control specification parameter 29, the set variable can be used as an exclusive control variable and a variable that has not been set can be used as a normal control variable. Therefore, with respect to a machining program currently created as an exclusive control variable, the exclusive control variable explained in the first and second embodiments can be easily executed by switching the exclusive-control specification parameter 29.

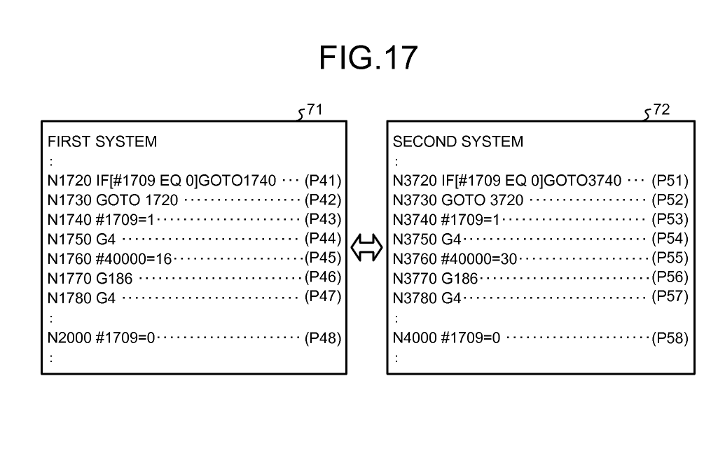

Operations when exclusive control is executed by using a conventional machining program are explained here. FIG. 17 is a diagram showing an example of a conventional machining program. In this example, machining programs 71 and 72 of two systems for executing exclusive control are shown. The machining program 71 is a machining program of a first system and the machining program 72 is a machining program of a second system.

In these machining programs 71 and 72, a different value is set in the variable #40000, which is common to the systems, in processes P43 to P48 and in processes P53 to P58, by using #1709, which is a variable common to the systems. Accordingly, the individual value of #40000 is used in each system to perform the operation of each system.

In the machining programs 71 and 72, when the first system performs a process P41 first, if the value of #1709 is “0”, the condition thereof is established and thus the process P43 is performed. Accordingly the value of #1709 becomes “1”. After the process P43 has been performed, when the second system performs a process P51, the condition thereof is not established in the process P51.

The condition of the process P51 is not established until #1709 becomes “0” in the first system, and the second system repeats the processes P51 to P53. While the second system is repeating the processes P51 to P53, the first system sets “16”, which is a value intended to be used by the first system, in #40000 in the process P45, thereby performing the individual operation of the first system. When #1709 becomes “0” in the process of P48 of the first system, the condition of the process P51 of the second system is established, and “30”, which is a value intended to be used by the second system, is set in #40000 in the process P55. Accordingly, the individual operation of the second system is performed. In this manner, the individual operation of each system is performed.

However, in the machining programs 71 and 72, both lines of the process P41 and the process P51 are executed in some cases before any line of the process 43 and the process 53 is executed. In this case, because #1709 is “0”, both conditions of the process P41 and the process P51 are established, and as a result, both the processes P43 and P53 are performed.

In this case, in the process P43 and the process P53, even if #1709 is set to “1”, both the processes P41 and P51 have already been performed; therefore, processes after the process P43 and the process P53 are not exclusively performed in both the systems. In such a case, although a different value is intended to be used for #40000 by the first system and the second system in the process P45 and the process P55, a value executed later is used. As a result, a desired operation of each system cannot be performed.

In contrast, in the first to third embodiments, when access permission is granted to any of the systems, the other systems are not granted access permission. Therefore, simultaneous access to common data and overwriting thereof before the common data is used can be prevented. Therefore, a desired operation of each system can be performed in the first to third embodiments.

### INDUSTRIAL APPLICABILITY

As described above, the numerical control device according to the present invention is suitable for executing exclusive control of each system.

### REFERENCE SIGNS LIST

1A to 1C NC device, 2 memory, 3A to 3C program analysis unit, 6 machine-control-signal processing unit, 9 shaft-data output unit, 11 exclusive control variable, 12 set-value storage area, 13 system-bit storage area, 25 machining-program storage unit, 26 parameter storage unit, exclusive-control specification parameter, 33 exclusive-control analysis unit, 34 program-stop control unit, 35 exclusive-control-variable specifying unit, 51, 52, 61, 62, 71, 72 machining program.

1. A numerical control device comprising:
a program storage unit that stores therein machining programs of respective systems; and
a program analysis unit that simultaneously executes the machining programs independently for each of the systems by analyzing the machining programs of the systems, wherein the machining program of each of the systems includes a control variable, which is a
common command for the systems, and one common value among the systems is saved in the control variable,
while the machining programs are simultaneously executed, in a case where the control variable is not being executed in a machining program of any of the systems, if execution of the a-control variable is started in a machining program of any of the systems, the program analysis unit permits only a system that has started the execution of the control variable to execute and overwrite the control variable, and does not permit another system other than the system that has started the execution of the control variable to execute and overwrite the control variable even when an attempt is made to execute the control variable in a machining program of the another system, and
when execution of the control variable is completed in the machining program of the system that has started the execution of the control variable, the program analysis unit permits any one of the systems to execute and overwrite the control variable.

2. The numerical control device according to claim 1, wherein while the program analysis unit permits only the system that has started the execution of the control variable to execute and overwrite the control variable, the program analysis unit designates the control variable as invalid even when the control variable is referred to in the machining program of the another system and designates the control variable as valid when the control variable is referred to in the machining program of the system that has started the execution of the control variable.

3. The numerical control device according to claim 2, wherein the program analysis unit manages permission information indicating whether execution and overwriting of the control variable is permitted for each of the systems, and determines whether the control variable is valid or invalid on a basis of the permission information.

4. A numerical control device comprising:
a program storage unit that stores therein machining programs of respective systems; and
a program analysis unit that simultaneously executes the machining programs independently for each of the systems by analyzing the machining programs of the systems, wherein
the machining program of each of the systems includes a control variable, which is a common command for the systems, and one common value among the systems is saved in the control variable,
while the machining programs are simultaneously executed, in a case where the control variable is not being executed in a machining program of any of the systems, if execution of the control variable is started in a machining program of any of the systems, the program analysis unit permits only a system that has started the execution of the control variable to execute and overwrite the control variable,
the program analysis unit stops, from among systems other than the system that has started the execution of the control variable, a machining program of a system that is trying to execute the control variable, and
when execution of the control variable is completed in the machining program of the system that has started the execution of the control variable, the program analysis unit resumes any one of the machining programs that have been stopped.

5. The numerical control device according to claim 4, wherein the program analysis unit manages execution information indicating whether the control variable is being executed for each of the systems, and determines whether to stop the machining program on a basis of the execution information.

6. The numerical control device according to claim 1, further comprising:
a parameter storage unit that stores therein a parameter of an exclusive control variable permitting execution and overwriting of the control variable in the systems; and
an exclusive-control determination unit that determines whether the control variable is the exclusive control variable on a basis of the parameter, wherein
when the control variable is the exclusive control variable, the control variable is caused to be executed by only any one of the systems.

7. The numerical control device according to claim 1, further comprising:
a parameter storage unit that stores therein a parameter of an exclusive control variable permitting execution and overwriting of the control variable in the systems; and
an exclusive-control determination unit that determines whether the control variable is the exclusive control variable on a basis of the parameter, wherein
when the control variable is the exclusive control variable, the control variable is caused to be executed by only any one of the systems.
